(19) United States
(12) Patent Application Publication
(10) Pub. No.: US 2025/0252131 A1
(43) Pub. Date: Aug. 7, 2025

(54) ELECTRONIC DEVICE FOR IDENTIFYING OBJECT, AND CONTROL METHOD THEREFOR

(71) Applicant: Samsung Electronics Co., Ltd., Suwon-si (KR)

(72) Inventors: Boyoung KIM, Suwon-si (KR); Nosan KWAK, Suwon-si (KR)

(21) Appl. No.: 19/185,949

(22) Filed: Apr. 22, 2025

Related U.S. Application Data
(63) Continuation of application No. PCT/KR2023/019330, filed on Nov. 28, 2023.

(30) Foreign Application Priority Data
Nov. 28, 2022 (KR) 10-2022-0161647
Dec. 7, 2022 (KR) 10-2022-0169634

(51) Int. Cl. G06F 16/55; G06V 10/74; G06V 10/764; G06V 10/774

(52) U.S. Cl. CPC G06F 16/55; G06V 10/74; G06V 10/764; G06V 10/774

(57) ABSTRACT

An electronic device is provided. The electronic device includes communication circuitry, memory storing one or more computer programs and one or more processors communicatively coupled to the communication circuitry and the memory, wherein the one or more computer programs include computer-executable instructions that, when executed by the one or more processors individually or collectively, cause the electronic device to obtain a plurality of computer-aided design (CAD) images based on CAD information of an object, classify the plurality of CAD images into a plurality of groups based on similarities between the plurality of CAD images, transmit a representative CAD image of each of the plurality of groups to an external electronic device, receive an object image captured by the external electronic device, corresponding to the representative CAD image, from the external electronic device, and generate a learning model to output the representative CAD image by using the received object image as training data.

### CROSS-REFERENCE TO RELATED APPLICATION(S)

This application is a continuation application, claiming priority under 35 U.S.C. § 365(c), of an International application No. PCT/KR2023/019330, filed on Nov. 28, 2023, which is based on and claims the benefit of a Korean patent application number 10-2022-0161647, filed on Nov. 28, 2022, in the Korean Intellectual Property Office, and of a Korean patent application number 10-2022-0169634, filed on Dec. 7, 2022, in the Korean Intellectual Property Office, the disclosure of each of which is incorporated by reference herein in its entirety.

### BACKGROUND

### 1. Field

The disclosure relates to an electronic device for identifying an object and a method of controlling the same.

### 2. Description of Related Art

In industrial sites, the pose of an object needs to be estimated frequently. The pose of an object on a conveyor changes every time, and the object is often picked up for inspection or assembly. It is also necessary to display inspection results and a pose for assembly.

When a learning algorithm is generated for estimating the pose of an object, an image of the object is captured, and a worker generates training data by dragging the pose and position of the object with a mouse, while looking at the image on a monitor.

Even after training, when viewing abnormal results or an assembly guide for the object, the worker should compare the image of the object displayed on the monitor with the object on an actual workbench, looking at them alternately, and there is a difference between an angle at which the object was captured and the pose of the object that the worker actually sees.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for identifying an object and a method of controlling the same.

Additional aspects will be set forth in part in the description which follows and, in part, will be apparent from the description, or may be learned by practice of the presented embodiments.

In accordance with an aspect of the disclosure, an electronic device is provided. The electronic device includes communication circuitry, memory storing one or more computer programs, and one or more processors communicatively coupled to the communication circuitry and the memory, wherein the one or more computer programs include computer-executable instructions that, when executed by the one or more processors individually or collectively, cause the electronic device to obtain a plurality of computer aided design (CAD) images based on CAD information of an object, classify the plurality of CAD images into a plurality of groups based on similarities between the plurality of CAD images, transmit a representative CAD image of each of the plurality of groups to an external electronic device, receive an image of the object captured by the external electronic device, corresponding to the representative CAD image, from the external electronic device, and generate a learning model to output the representative CAD image, using the received image of the object as training data.

In accordance with another aspect of the disclosure, an electronic device is provided. The electronic device includes communication circuitry, memory storing one or more computer programs, and one or more processors communicatively coupled to the communication circuitry and the memory, wherein the one or more computer programs include computer-executable instructions that, when executed by the one or more processors individually or collectively, cause the electronic device to receive an image of an object captured by an external electronic device from the external electronic device, obtain a representative computer aided design (CAD) image from a learning model stored in the memory, using the received image as input data, identify a group including the obtained representative CAD image among a plurality of groups into which a plurality of CAD images obtained based on CAD information of the object are classified, identify a CAD image mapped to the received image among a plurality of CAD images included in the group, and transmit information related to the mapped CAD image to the external electronic device, and wherein the learning model is trained to output a representative CAD image, using the plurality of CAD images obtained based on the CAD information of the object as training data.

In accordance with another aspect of the disclosure, a method performed by an electronic device is provided. The method includes obtaining, by the electronic device, a plurality of computer aided design (CAD) images based on CAD information of an object, classifying, by the electronic device, the plurality of CAD images into a plurality of groups based on similarities between the plurality of CAD images, transmitting, by the electronic device, a representative CAD image of each of the plurality of groups to an external electronic device, receiving, by the electronic device, an image of the object captured by the external electronic device, corresponding to the representative CAD image, from the external electronic device, and generating, by the electronic device, a learning model to output the representative CAD image, using the received image of the object as training data.

According to an embodiment, a method includes receiving an image of an object captured by an external electronic device from the external electronic device.

According to an embodiment, the method includes obtaining a representative CAD image from a learning model stored in the memory, using the received image as input data.

According to an embodiment, the method includes identifying a group including the obtained representative CAD image among a plurality of groups into which a plurality of CAD images obtained based on CAD information of the object are classified.

According to an embodiment, the method includes identifying a CAD image mapped to the received image among a plurality of CAD images included in the group.

According to an embodiment, the method of controlling the electronic device includes transmitting information related to the mapped CAD image to the external electronic device.

According to an embodiment, the learning model is trained to output a representative CAD image, using the plurality of CAD images obtained based on the CAD information of the object as training data.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include obtaining, by the electronic device, a plurality of computer-aided design (CAD) images based on CAD information of an object, classifying, by the electronic device, the plurality of CAD images into a plurality of groups based on similarities between the plurality of CAD images, transmitting, by the electronic device, a representative CAD image of each of the plurality of groups to an external electronic device, receiving, by the electronic device, an image of the object captured by the external electronic device, corresponding to the representative CAD image, from the external electronic device, and generating, by the electronic device, a learning model to output the representative CAD image, using the received image of the object as training data.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a perspective view illustrating internal components of a wearable electronic device according to an embodiment of the disclosure;

FIG. 3A is a diagram illustrating the front surface of a wearable electronic device according to an embodiment of the disclosure;

FIG. 3B is a diagram illustrating the rear surface of a wearable electronic device according to an embodiment of the disclosure;

FIG. 4 is another perspective view illustrating a wearable electronic device according to an embodiment of the disclosure;

FIG. 5 is a flowchart illustrating an operation of training a deep learning model for object identification in an electronic device according to an embodiment of the disclosure;

FIG. 6 is a diagram illustrating an operation of training a deep learning model for object identification in an electronic device according to an embodiment of the disclosure;

FIG. 7 is a diagram illustrating a classification structure of object CAD images according to an embodiment of the disclosure;

FIG. 8A is a diagram illustrating an operation of displaying a guide image in a wearable electronic device according to an embodiment of the disclosure;

FIG. 8B is a diagram illustrating an operation of displaying a guide image in a wearable electronic device according to an embodiment of the disclosure;

FIG. 9 is a flowchart illustrating an operation of training a deep learning model for object identification in a wearable electronic device according to an embodiment of the disclosure;

FIG. 10 is a flowchart illustrating an operation of identifying an object using a deep learning model in an electronic device according to an embodiment of the disclosure;

FIG. 11 is a diagram illustrating an operation of identifying an object using a deep learning model in an electronic device according to an embodiment of the disclosure;

FIG. 12 is a diagram illustrating an operation of identifying a mapped CAD image based on a classification structure of object CAD images in an electronic device according to an embodiment of the disclosure;

FIG. 13 is a diagram illustrating an operation of using an identified CAD image in an electronic device according to an embodiment of the disclosure;

FIG. 14 is a flowchart illustrating an operation of identifying an object using a deep learning model in a wearable electronic device according to an embodiment of the disclosure;

FIG. 15 is a diagram illustrating an operation of precisely identifying an object based on a mapped CAD image in an electronic device according to an embodiment of the disclosure;

FIG. 16 is a diagram illustrating a precision identification operation of an electronic device according to an embodiment of the disclosure;

FIG. 17 is a diagram illustrating a precision identification operation of an electronic device according to an embodiment of the disclosure;

FIG. 18 is a diagram illustrating a precision identification operation of an electronic device according to an embodiment of the disclosure;

FIG. 19 is a diagram illustrating a precision identification operation of an electronic device according to an embodiment of the disclosure;

FIG. 20 is a flowchart illustrating an operation of training a deep learning model for identifying whether an object is defective based on three dimensional (3D) data in an electronic device according to an embodiment of the disclosure; and

FIG. 21 is a flowchart illustrating an operation of identifying whether an object is defective using a deep learning model trained based on 3D data in an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a nearfield communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

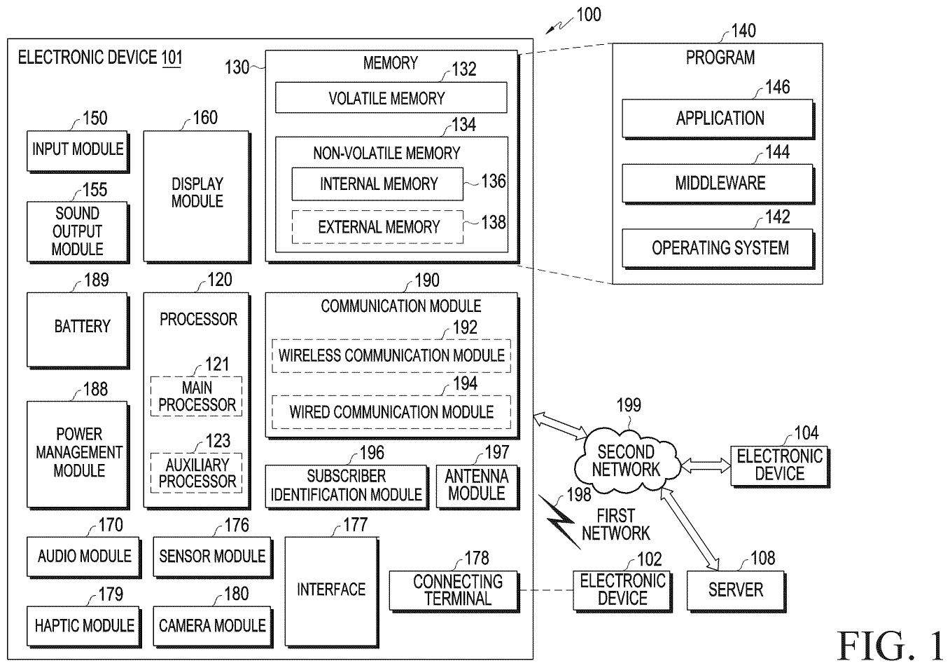

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the strength of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (I R) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LA N or wide area network (WA N)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IM SI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mM TC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form an mmWave antenna module. According to an embodiment, the mmWave antenna module may include a printed circuit board, a R FIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed atone or more of the external electronic devices 102, or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

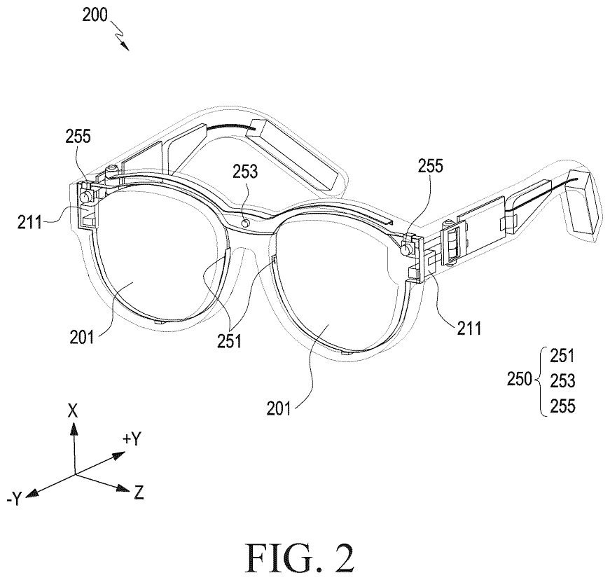

FIG. 2 is a perspective view illustrating internal components of a wearable electronic device according to an embodiment of the disclosure.

Referring to FIG. 2, a wearable electronic device 200 according to an embodiment may include at least one of a light output module 211, a display member 201, and a camera module 250.

According to an embodiment, the light output module 211 may include a light source capable of outputting an image, and a lens that guides the image to the display member 201. According to an embodiment, the light output module 211 may include at least one of a liquid crystal display (LCD), a digital micromirror device (DMD), a liquid crystal on silicon (LCoS), an organic light emitting diode (OLED), or a micro light emitting diode (LED).

According to an embodiment, the display member 201 may include an optical waveguide (e.g., a waveguide). According to an embodiment, an output image of the light output module 211 incident on one end of the optical waveguide may be propagated through the optical waveguide and provided to a user. According to an embodiment, the optical waveguide may include at least one of a diffractive element (e.g., a diffractive optical element (DOE) or a holographic optical element (HOE)) or a reflective element (e.g., a reflective mirror). For example, the optical waveguide may guide the output image of the light output module 211 to the user's eye by using at least one diffractive element or reflective element.

According to an embodiment, the camera module 250 may capture a still image and/or a video. According to an embodiment, the camera module 250 may be disposed within a lens frame and disposed around the display member 201.

According to an embodiment, a first camera module 251 may capture and/or recognize the trajectory of the user's eye (e.g., pupil or iris) or gaze. According to an embodiment, the first camera module 251 may periodically or aperiodically transmit information (e.g., trajectory information) related to the trajectory of the user's eye or gaze to a processor (e.g., the processor 120 of FIG. 1).

According to an embodiment, a second camera module 253 may capture an external image.

According to an embodiment, a third camera module 255 may be used for hand detection and tracking, and user gesture (e.g., hand movement) recognition. The third camera module 255 according to an embodiment may be used for 3 degrees of freedom (3DoF) or 6DoF head tracking, location (space or environment) recognition, and/or movement recognition. The second camera module 253 may also be used for hand detection and tracking, and user gesture recognition according to an embodiment. According to an embodiment, at least one of the first camera module 251 to the third camera module 255 may be replaced with a sensor module (e.g., a LiDAR sensor). For example, the sensor module may include at least one of a vertical cavity surface emitting laser (VCSEL), an IR sensor, and/or a photodiode.

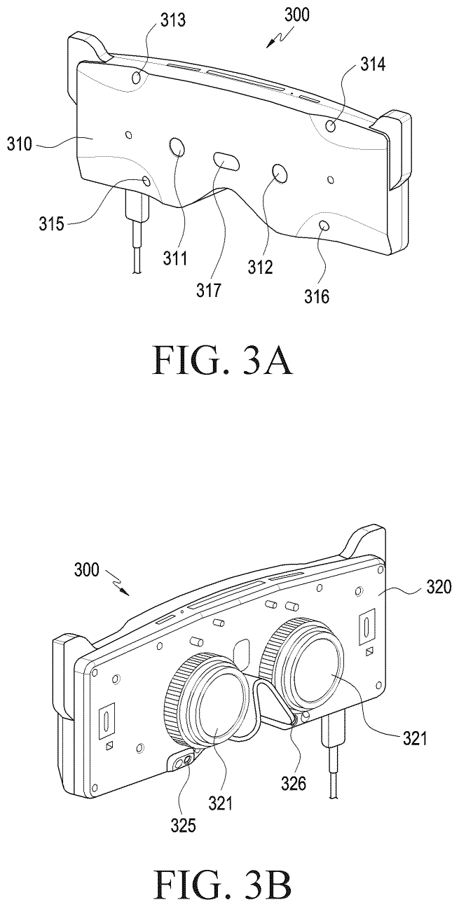

FIG. 3A is a diagram illustrating the front surface of a wearable electronic device according to an embodiment of the disclosure.

FIG. 3B is a diagram illustrating the rear surfaces of a wearable electronic device according to an embodiment of the disclosure.

Referring to FIGS. 3A and 3B, in an embodiment, camera modules 311, 312, 313, 314, 315, and 316 and/or a depth sensor 317 may be disposed on a first surface 310 of a housing to obtain information related to a surrounding environment of a wearable electronic device 300.

In an embodiment, the camera modules 311 and 312 may obtain an image related to the surrounding environment of the wearable electronic device.

In an embodiment, the camera modules 313, 314, 315, and 316 may obtain an image, while the wearable electronic device is worn by the user. The camera modules 313, 314, 315, and 316 may be used for hand detection and tracking, and user gesture (e.g., hand movement) recognition. The camera modules 313, 314, 315, and 316 may be used for 3DoF or 6DoF head tracking, location (space or environment) recognition, and/or movement recognition. In an embodiment, the camera modules 311 and 312 may also be used for hand detection and tracking, and user gesture recognition.

In an embodiment, the depth sensor 317 may be configured to transmit a signal and receive a signal reflected from an object, and used for the purpose of identifying a distance to an object, such as time of flight (TOF). Alternatively or additionally to the depth sensor 317, the camera modules 313, 314, 315, and 316 may identify a distance to an object.

According to an embodiment, face recognition camera modules 325 and 326 and/or a display 321 (and/or a lens) may be disposed on a second surface 320 of the housing.

In an embodiment, the face recognition camera modules 325 and 326 adjacent to the display may be used for the purpose of recognizing the user's face or may recognize and/or track both eyes of the user.

In an embodiment, the display 321 (and/or the lens) may be disposed on the second surface 320 of the wearable electronic device 300. In an embodiment, the wearable electronic device 300 may not include the camera modules 315 and 316 among the plurality of camera modules 313, 314, 315, and 316. Although not shown in FIGS. 3A and 3B, the wearable electronic device 300 may further include at least one of the components illustrated in FIG. 2.

As described above, according to an embodiment, the wearable electronic device 300 may have a form factor for being worn on the user's head. The wearable electronic device 300 may further include a strap and/or wearing member to be secured on a body part of the user. The wearable electronic device 300 may provide a user experience based on augmented reality, virtual reality, and/or mixed reality, while worn on the user's head.

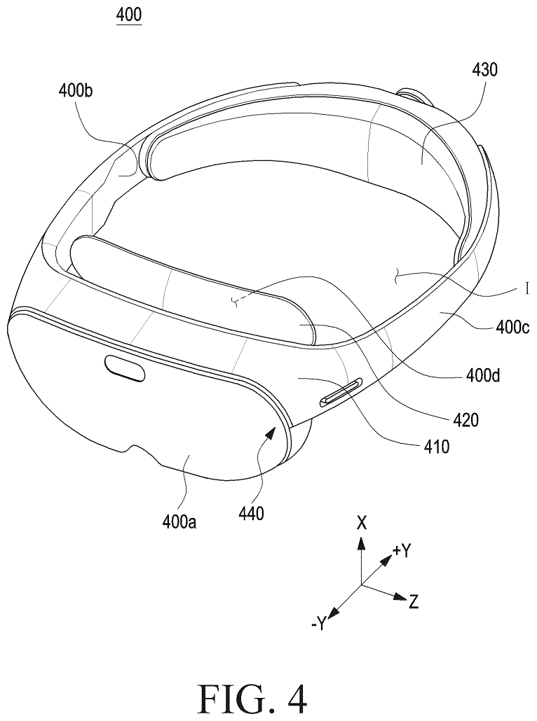

FIG. 4 is another perspective view illustrating an electronic device according to an embodiment of the disclosure.

Referring to FIG. 4, an electronic device 400 may be a head mounted display (HM D) device capable of providing an image in front of a user's eyes. The configuration of the electronic device 400 in FIG. 4 may be wholly or partially the same as the configuration of the electronic device 200 in FIG. 2.

According to an embodiment, the electronic device 400 may include housings 410, 420, and 430 that may form the exterior of the electronic device 400 and provide spaces in which components of the electronic device 400 may be disposed.

According to an embodiment, the electronic device 400 may include a first housing 410 that may surround at least a portion of the user's head. In an embodiment, the first housing 410 may include a first surface 400a facing the outside (e.g., in the −Y direction) of the electronic device 400.

According to an embodiment, the first housing 410 may surround at least a portion of an internal space I. For example, the first housing 410 may include a second surface 400b facing the internal space I of the electronic device 400 and a third surface 400c opposite to the second surface 400b. According to an embodiment, the first housing 410 may be combined with the third housing 430 to form a closed curve shape surrounding the internal space I.

According to an embodiment, the first housing 410 may accommodate at least some of the components of the electronic device 400. For example, a light output module and a circuit board may be disposed within the first housing 410.

According to an embodiment, the electronic device 400 may include one display member 440 corresponding to the left and right eyes. The display member 440 may be disposed in the first housing 410. The configuration of the display member 440 in FIG. 4 may be wholly or partially the same as the configuration of the display member 201 in FIG. 2.

According to an embodiment, the electronic device 400 may include a second housing 420 that may be mounted on the user's face. According to an embodiment, the second housing 420 may include a fourth surface 400d that may face at least a portion of the user's face. According to an embodiment, the fourth surface 400d may be a surface facing the internal space I of the electronic device 400 (e.g., in the +Y direction). According to an embodiment, the second housing 420 may be coupled to the first housing 410.

According to an embodiment, the electronic device 400 may include a third housing 430 that may be mounted on the back of the user's head. According to an embodiment, the third housing 430 may be coupled to the first housing 410. According to an embodiment, the third housing 430 may accommodate at least some of the components of the electronic device 400. For example, a battery (e.g., the battery 189 of FIG. 1) may be disposed within the third housing 430.

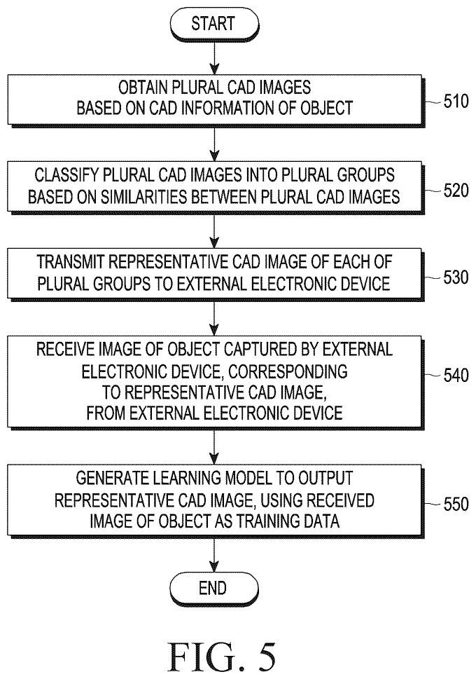

FIG. 5 is a flowchart illustrating an operation of training a deep learning model for object identification in an electronic device according to an embodiment of the disclosure.

Referring to FIG. 5, in operation 510, the electronic device (e.g., the electronic device 101 of FIG. 1 or the processor 120 of FIG. 1) may obtain a plurality of computer aided design (CAD) images based on CAD information of an object.

According to an embodiment, the electronic device may obtain a plurality of CAD images from CAD data of the object received from a server (e.g., the server 108 of FIG. 1) and/or CAD data of the object stored in memory (e.g., the memory 130 of FIG. 1).

According to an embodiment, the plurality of CAD images may correspond to the object placed on different surfaces and/or in different directions, respectively.

According to an embodiment, in operation 520, the electronic device may classify the plurality of CAD images into a plurality of groups based on similarities between the plurality of CAD images.

According to an embodiment, the electronic device may classify the plurality of CAD images into a tree structure based on the similarities between the plurality of CAD images.

According to an embodiment, the electronic device may calculate scores between the plurality of CAD images by converting them to a structural similarity index measure (SSIM) and/or a perspectively cumulated orientation feature (PCOF) between the plurality of CAD images. The SSIM may be calculated by Equation 1 below. SSIM may return a value or score between 0 and 1 that indicates the similarity between two CAD images. The closer the SSIM value is to 1, the more similar the two CAD images are, and the closer the SSIM value is to 0, the greater the difference between the two CAD images. To measure the similarity between two CAD images using PCOFs (or a PCOF vectors), the PCOFs (or the PCOF vectors) representing rotation, orientation, and/or geometric properties of the object may be extracted from the two CAD images. Then, the cosine similarity, Euclidean distance, or correlation coefficient between the PCOFs (or PCOF vectors) of the two CAD images may be calculated. The closer the cosine similarity between the PCOFs (or PCOF vectors) of the two CAD images is to 1, the more similar the two CAD images are, and the closer the cosine similarity between the PCOFs (or PCOF vectors) of the two CAD images is to 0, the greater the difference between the two CAD images is.

$$SSIM ( x , x ) = \frac{( 2 {μ}_{x} {μ}_{y} + {C}_{1} ) ( 2 {σ}_{xy} + {C}_{2} )}{( {μ}_{x}^{2} + {μ}_{y}^{2} + {C}_{1} ) ( {σ}_{x}^{2} + {σ}_{y}^{2} + {C}_{2} )} \qquad Equation 1$$

Herein, x or y is the index of each image, μₓ is a pixel sample mean of x, μ_{y} is a pixel sample mean of y, σₓ² is a variance of x, σ_{y}² is a variance of y, and σ_{xy} is a covariance of x and y.

According to an embodiment, C₁ may be (k₁L)², and C₂ may be (k₂L)².

Herein, L may be a dynamic range of pixel values. By default, k₁ may be 0.01, and k₂ may be 0.03.

According to an embodiment, the electronic device may group a plurality of CAD images (or templates) having similarity scores equal to or greater than a predetermined threshold into the same group. According to an embodiment, the electronic device may generate an upper tree by grouping similar CAD images while lowering a resolution.

For example, the electronic device may classify the plurality of CAD images into a plurality of first groups based on similarities, and identify a plurality of first representative CAD images corresponding to the plurality of first groups, respectively.

According to an embodiment, the electronic device may classify the plurality of first representative CAD images into a plurality of second groups based on similarities, and identify a plurality of second representative CAD images corresponding to the plurality of second groups, respectively. According to an embodiment, the plurality of second groups may be upper groups of the plurality of first groups.

According to an embodiment, the representative CAD images of the upper groups including the representative CAD images of the lower groups may be final representative CAD images of the plurality of grouped CAD images.

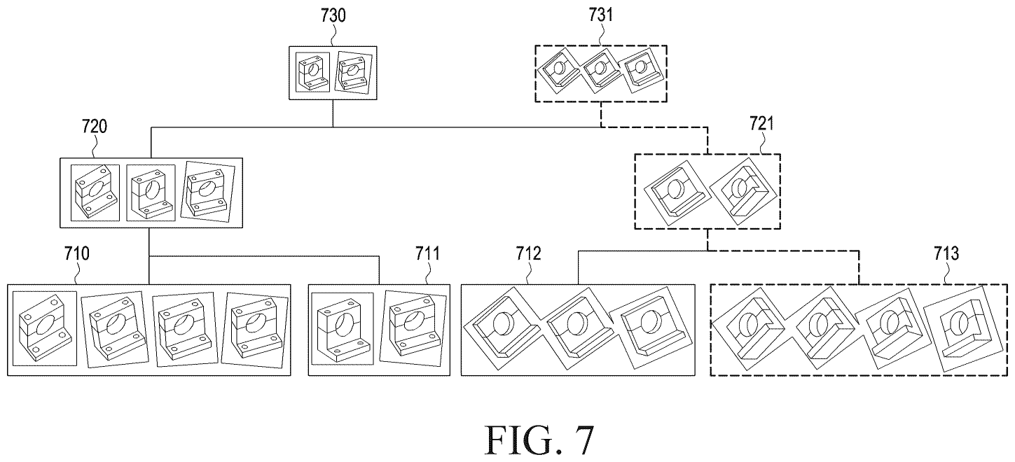

A classification structure of a plurality of CAD images according to an embodiment will be described below with reference to FIG. 7.

According to an embodiment, in operation 530, the electronic device may transmit the representative CAD images of the plurality of groups to an external electronic device (e.g., the electronic device 104 of FIG. 1, the electronic device 200 of FIG. 2, the electronic device 300 of FIG. 3A or 3B, or the electronic device 400 of FIG. 4).

According to an embodiment, the electronic device may transmit the plurality of second representative CAD images as the representative CAD images to the external electronic device. For example, the electronic device may transmit the representative CAD images of the upper groups to the external electronic device.

According to an embodiment, the electronic device may sequentially transmit a first guide image including a first CAD image related to a first pose of the object and a second guide image including a second CAD image related to a second pose of the object among the plurality of representative CAD images to the external electronic device.

For example, upon receipt of an image of the object corresponding to the first guide image after transmitting the first guide image to the external electronic device, the electronic device may sequentially transmit the second guide image to the external electronic device.

According to an embodiment, the electronic device may transmit the first guide image and the second guide image together to the external electronic device.

According to an embodiment, at least one of the first guide image or the second guide image may include a guide for guiding a pose of the object to be changed. According to an embodiment, the guide may include a guide phrase, a guide voice, and/or a guide highlight.

According to an embodiment, the external electronic device may sequentially display the first guide image and the second guide image.

According to an embodiment, three or more guide images may be transmitted to the external electronic device.

According to an embodiment, the external electronic device may be augmented reality (AR) glasses. According to an embodiment, the external electronic device may be an HMD device or an electronic device including a display and a camera.

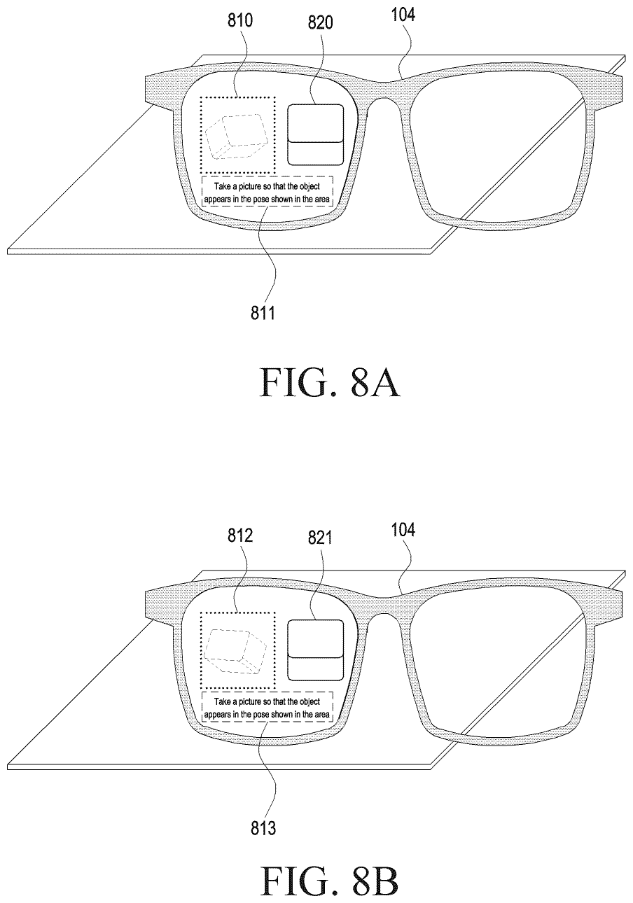

According to an embodiment, the operation of displaying a guide image by the external electronic device will be described with reference to FIGS. 8A and 8B below.

According to an embodiment, in operation 540, the electronic device may receive an image of the object captured by the external electronic device, corresponding to a representative CAD image, from the external electronic device.

According to an embodiment, the received image of the object may be an image of the object whose pose has been changed by the user based on the display of the guide image.

According to an embodiment, in operation 550, the electronic device may generate a learning model to output the representative CAD image, using the received image of the object as training data. For example, the learning model may be a deep learning model or a general calculation model. According to an embodiment, the ‘general calculation model’ may be applied to an operation to which the ‘deep learning model’ is applied.

In this way, the deep learning model may be trained on an initial pose of an object by classifying a plurality of CAD images into a tree structure, obtaining a representative CAD image, and outputting the representative CAD image by using an object image corresponding to the representative CAD image as input data.

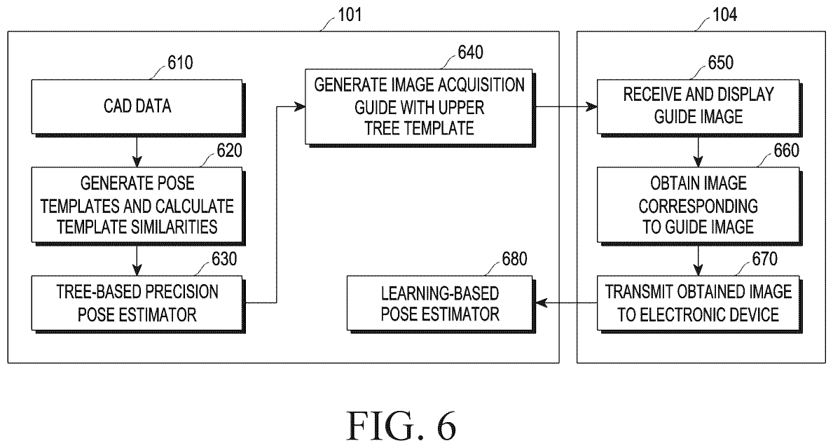

FIG. 6 is a diagram illustrating an operation of training a deep learning model for object identification in an electronic device according to an embodiment of the disclosure.

Referring to FIG. 6, the electronic device 101 (e.g., the electronic device 101 of FIG. 1 or the processor 120 of FIG. 1) may obtain CAD data of an object in operation 610.

According to an embodiment, the electronic device may obtain a plurality of CAD images from CAD data of the object received from a server (e.g., the server 108 of FIG. 1) and/or CAD data of the object stored in memory (e.g., the memory 130 of FIG. 1).

According to an embodiment, in operation 620, the electronic device 101 may generate pose templates (or CAD images) and calculate similarities between the templates.

According to an embodiment, the electronic device may calculate similarities between the plurality of CAD images by converting them into a SSIM and/or PCOFs (or the PCOF vectors).

According to an embodiment, in operation 630, the electronic device 101 may classify the CAD images into a tree structure, for precise pose estimation.

According to an embodiment, the electronic device may classify a plurality of pose templates into a tree structure based on similarities. For example, the electronic device may classify the plurality of pose templates into a plurality of first groups, and identify representative pose templates of the plurality of first groups, respectively.

According to an embodiment, the electronic device may classify the plurality of first pose templates into a plurality of second groups based on similarities, and identify a plurality of second representative pose templates corresponding to the plurality of second groups, respectively. According to an embodiment, the plurality of second groups may be upper groups of the plurality of first groups.

According to an embodiment, the representative pose templates of upper groups including the representative pose templates of lower groups may be final upper pose templates of the grouped plurality of pose templates.

The classification structure of a plurality of pose templates according to an embodiment will be described below with reference to FIG. 7.

According to an embodiment, in operation 640, the electronic device 101 may generate an image acquisition guide with an upper template.

According to an embodiment, the electronic device may generate an image acquisition guide with a final upper pose template of the tree structure. According to an embodiment, each image acquisition guide may include a guide for guiding a pose of the object and/or a change in the pose of the object. According to an embodiment, the guide may include a guide phrase, a guide voice, and/or a guide image.

According to an embodiment, the electronic device may transmit the image acquisition guide to an external electronic device 104 (e.g., the electronic device 104 of FIG. 1, the electronic device 200 of FIG. 2, the electronic device 300 of FIG. 3A or 3B, or the electronic device 400 of FIG. 4).

According to an embodiment, the external electronic device 104 (e.g., the electronic device 104 of FIG. 1, the electronic device 200 of FIG. 2, the electronic device 300 of FIG. 3A or 3B, or the electronic device 400 of FIG. 4) may receive and display the guide image from the electronic device 101 in operation 650.

According to an embodiment, the external electronic device 104 may further display a guide for guiding the pose of the object to be changed.

According to an embodiment, the operation of displaying the guide image by the external electronic device 104 will be described with reference to FIGS. 8A and 8B below.

According to an embodiment, in operation 660, the external electronic device 104 may obtain an image corresponding to the guide image.

According to an embodiment, the external electronic device 104 may obtain the image of the object corresponding to the guide image, using a camera included in the external electronic device 104.

According to an embodiment, in operation 670, the external electronic device 104 may transmit the obtained image to the electronic device.

According to an embodiment, in operation 680, the electronic device 101 may train a deep learning model based on the received image.

According to an embodiment, the deep learning model may use recurrent 6-DoF object pose refinement with robust correspondence field estimation and pose optimization (RNN Pose), a scalable, accurate, robust to partial occlusion method for predicting the 3d poses of challenging objects without using depth (BB8), and/or a 6d pose object detector and refiner (DPOD).

As such, the guide image may displayed on the display of AR glasses, which may obviate the need for the user to adjust the pose of the object, while viewing the display and the object alternately, and thus shorten a time required to obtain an image to be used as training data.

FIG. 7 is a diagram illustrating a classification structure of CAD images of an object according to an embodiment of the disclosure.

Referring to FIG. 7, an electronic device (e.g., the electronic device 101 of FIG. 1, the processor 120 of FIG. 1, the electronic device 200 of FIG. 2, the electronic device 300 of FIG. 3A or 3B, or the electronic device 400 of FIG. 4) may obtain a plurality of CAD images 710, 711, 712, and 713 based on CAD data of an object.

According to an embodiment, the electronic device may classify the plurality of CAD images into a (1-1)^{th} group 710, a (1-2)^{th} group 711, a (1-3)^{th} group 712, and/or a (1-4)^{th} group 713 based on similarities, and identify a representative CAD image of each of the first groups 710, 711, 712, and 713 (i.e., (1-1)^{th} group 710, the (1-2)^{th} group 711, the (1-3)^{th} group 712, and the (1-4)^{th} group 713).

According to an embodiment, the electronic device may classify the representative CAD images of the first groups 710, 711, 712, and 713 (i.e., the (1-1)^{th} group 710, the (1-2)^{th} group 711, the (1-3)^{th} group 712, and the (1-4)^{th} group 713) into a plurality of second groups 720 and 721 based on similarities. According to an embodiment, the electronic device may classify the representative CAD images of the respective first groups 710, 711, 712, and 713 (i.e., the (1-1)^{th} group 710, the (1-2)^{th} group 711, the (1-3)^{th} group 712, and the (1-4)^{th} group 713) into a (2-1)^{th} group 720 and/or a (2-2)^{th} group 721 based on similarities, and identify representative CAD images 730 and 731 of the second groups 720 and 721 (i.e., (2-1)^{th} group 720 and the (2-2)^{th} group 721), respectively.

In this way, the electronic device may classify a plurality of CAD images into a tree structure, and search for a mapped CAD image only in the CAD images of a group including a representative CAD image for an image of an object, thereby reducing search resources and a search time.

FIG. 8A is a diagram illustrating an operation of displaying a guide image in a wearable electronic device according to an embodiment of the disclosure.

Referring to FIG. 8A, the external electronic device 104 (e.g., the electronic device 104 of FIG. 1, the electronic device 200 of FIG. 2, the electronic device 300 of FIG. 3A or 3B, or the electronic device 400 of FIG. 4) may display a first guide image 810 received from an electronic device (e.g., the electronic device 101 of FIG. 1) or generated by the external electronic device 104 on a display. According to an embodiment, the display of the external electronic device 104 may be transparent to light, and the user may view an object 820 located opposite to the user's eyes, with the display of the external electronic device 104 interposed therebetween.

According to an embodiment, the first guide image 810 may be a representative CAD image of the object.

According to an embodiment, the external electronic device 104 may display a guide phrase 811 (e.g., “Take a picture so that the object appears in the pose shown in the area”, which guides the pose of the object 820 to be changed, together with the first guide image 810.

According to an embodiment, the external electronic device 104 may sequentially display a second guide image 812 as illustrated in FIG. 8B, after displaying the first guide image 810 as illustrated in FIG. 8A.

FIG. 8B is a diagram illustrating an operation of displaying a guide image in a wearable electronic device according to an embodiment of the disclosure.

Referring to FIG. 8B, the external electronic device 104 may display the second guide image 812. According to an embodiment, the second guide image 812 may include a CAD image of the object in a different pose from the pose in the CAD image of the object included in the first guide image 810.

According to an embodiment, the external electronic device 104 may display a guide phrase 813 (e.g., “Take a picture so that the object appears in the pose shown in the area”), which guides the pose of the object 821 to be changed, together with the second guide image 812.

In this way, since a guide image and a pose of an object to be obtained may be viewed together through the display of the external electronic device 104, post-processing of data for training the deep learning model is not required, and the user may generate an image for training data without leaving a workbench.

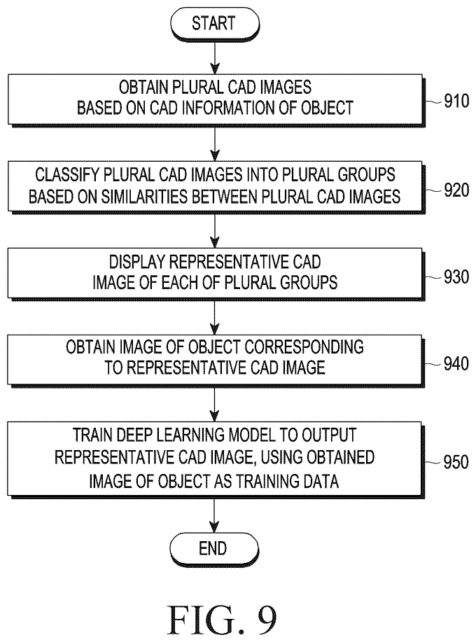

FIG. 9 is a flowchart illustrating an operation of training a deep learning model for object identification in a wearable electronic device according to an embodiment. According to an embodiment of the disclosure.

FIG. 9 is a diagram illustrating an operation of training a deep learning model, when an electronic device is a wearable electronic device (e.g., AR glasses and/or an HMD device).

Referring to FIG. 9, in operation 910, the electronic device (e.g., the electronic device 101 of FIG. 1, the processor 120 of FIG. 1, the electronic device 200 of FIG. 2, the electronic device 300 of FIG. 3A or 3B, or the electronic device 400 of FIG. 4) may obtain a plurality of CAD images based on CAD information of an object.

According to an embodiment, operation 910 is the same as operation 510 of FIG. 5, and thus a redundant description is avoided.

According to an embodiment, in operation 920, the electronic device may classify the plurality of CAD images into a plurality of groups based on similarities between the plurality of CAD images.

According to an embodiment, operation 920 is the same as operation 520 of FIG. 5, and thus a redundant description is avoided.

According to an embodiment, in operation 930, the electronic device may display a representative CAD image of each of the plurality of groups.

According to an embodiment, the electronic device may display the representative CAD image through a display (e.g., the display module 160 of FIG. 1, the display member 201 of FIG. 2, the display 321 of FIG. 3B, or the display member 440 of FIG. 4) of the electronic device, without transmitting the representative CAD image to an external electronic device as in operation 530 of FIG. 5.

According to an embodiment, the electronic device may sequentially display a first guide image including a first CAD image related to a first pose of the object and a second guide image including a second CAD image related to a second pose of the object among the plurality of representative CAD images on the electronic device.

According to an embodiment, at least one of the first guide image or the second guide image may include a guide phrase for guiding the pose of the object to be changed.

According to an embodiment, in operation 940, the electronic device may obtain an image of the object corresponding to the representative CAD image.

According to an embodiment, the electronic device may obtain an image of the object through a camera (e.g., the camera module 180 of FIG. 1, the second camera module 253 of FIG. 2, the third camera module 255 of FIG. 2, or the camera modules 311, 312, 313, 314, 315, and 316 of FIG. 3A).

According to an embodiment, the electronic device may obtain an image of the object whose pose has been changed to correspond to the first guide image or the second guide image by the user.

According to an embodiment, in operation 950, the electronic device may train a deep learning model to output the representative CAD image, using the obtained image as training data.

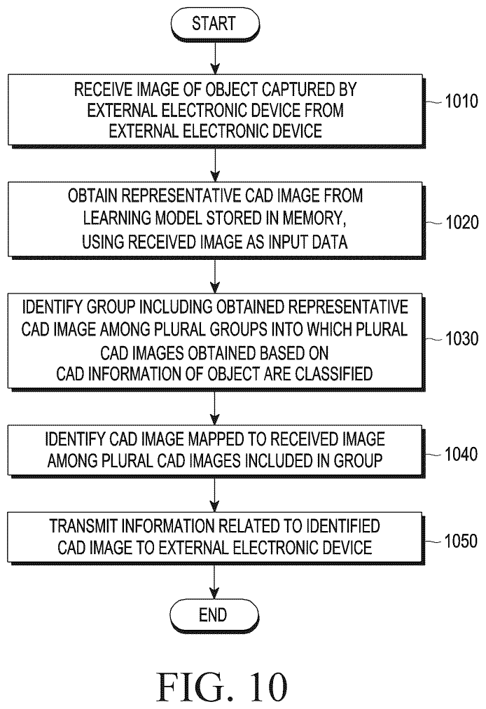

FIG. 10 is a flowchart illustrating an object identification operation using a deep learning model in an electronic device according to an embodiment of the disclosure.

OM Referring to FIG. 10, in operation 1010, the electronic device (e.g., the electronic device 101 of FIG. 1 or the processor 120 of FIG. 1) may receive an image captured by an external electronic device (e.g., the electronic device 104 of FIG. 1, the electronic device 200 of FIG. 2, the electronic device 300 of FIG. 3A or 3B, or the electronic device 400 of FIG. 4) from the external electronic device.

According to an embodiment, the received image may be captured by a camera of the external electronic device, and may be captured after a guide image transmitted from the electronic device to the external electronic device is displayed on the external electronic device.

According to an embodiment, in operation 1020, the electronic device may obtain a representative CAD image from a learning model stored in memory (e.g., the memory 130 of FIG. 1) using the received image as input data. For example, the learning model may be a deep learning model or a general calculation model. According to an embodiment, the ‘general calculation model’ may also be applied to an operation to which the ‘deep learning model’ is applied.

According to an embodiment, the electronic device may obtain the representative CAD image corresponding to the received image based on a similarity between the received image and each of a plurality of representative CAD images.

According to an embodiment, in operation 1030, the electronic device may identify a group including the obtained representative CAD image among a plurality of groups into which a plurality of CAD images obtained based on CAD information of the object have been classified.

According to an embodiment, the electronic device may identify an upper group including the representative CAD image and each lower group included in the upper group.

According to an embodiment, in operation 1040, the electronic device may identify a CAD image mapped to the received image among a plurality of CAD images included in the group.

According to an embodiment, the electronic device may identify a plurality of CAD images of the group including the representative CAD image corresponding to the received image among the plurality of CAD images of the object, and identify the CAD image mapped to the received image among a plurality of CAD images of a lower group including the representative CAD image.

According to an embodiment, the electronic device may identify the CAD image mapped to the received image among the plurality of CAD images included in the identified group based on similarities with the received image.

According to an embodiment, in operation 1050, the electronic device may transmit information related to the identified CAD image to the external electronic device.

According to an embodiment, the electronic device may identify a defective portion of the object included in the received image based on the information related to the mapped CAD image, and transmit an image including a guide for guiding the defective portion to be identified to the external electronic device.

According to an embodiment, the electronic device may identify the defective portion of the object by comparing the mapped CAD image with the received image. For example, the electronic device may compare the mapped CAD image with the received image, and when at least one feature value included in the received image is different from at least one feature value included in the mapped CAD image by a set range or more, the electronic device may identify the at least one feature value as a defective portion of the object.

According to an embodiment, the electronic device may transmit, to the external electronic device, an image including an assembly guide for assembling the object included in the received image as a part of an assembly based on the information related to the mapped CAD image.

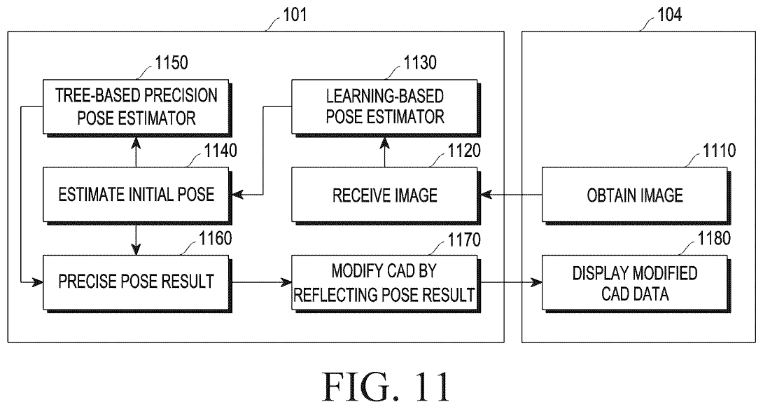

FIG. 11 is a diagram illustrating an object identification operation using a deep learning model in an electronic device according to an embodiment of the disclosure.

Referring to FIG. 11, in operation 1110, the external electronic device 104 (e.g., the electronic device 104 of FIG. 1, the electronic device 200 of FIG. 2, the electronic device 300 of FIG. 3A or 3B, or the electronic device 400 of FIG. 4) may obtain an image.

According to an embodiment, the external electronic device 104 may capture the image after a guide image transmitted from the electronic device 101 (e.g., the electronic device 101 of FIG. 1 or the processor 120 of FIG. 1) to the external electronic device 104 is displayed on the external electronic device 104.

For example, the external electronic device 104 may capture the image by the user input after displaying the guide image, capture the image when a set time has elapsed after displaying the guide image, or capture the image when the pose of a product is detected to be similar to that in a CAD image included in the guide image after displaying the guide image.

According to an embodiment, the image captured by the external electronic device 104 may be transmitted to the electronic device 101.

According to an embodiment, in operation 1120, the electronic device 101 may receive the image from the external electronic device 104.

According to an embodiment, the electronic device 101 may input the received image to a learning-based pose estimator 1130 (e.g., a deep learning model).

According to an embodiment, in operation 1140, the electronic device 101 may estimate an initial pose of the object. According to an embodiment, the electronic device 101 may obtain an initial pose (e.g., a representative CAD image) of the object included in the received image through the learning-based pose estimator 1130.

According to an embodiment, the electronic device 101 may obtain a representative CAD image corresponding to the received image based on a similarity between the received image and each of a plurality of representative CAD images.

According to an embodiment, in operation 1150, the electronic device 101 may perform tree-based precise pose (e.g., CAD image) estimation based on the initial pose.

According to an embodiment, the electronic device 101 may identify a group including the initial pose (e.g., the representative CAD image) corresponding to the received image among a plurality of groups into which a plurality of CAD images obtained based on CAD information of the object have been classified.

According to an embodiment, the electronic device 101 may identify an upper group including the initial pose of the object and each lower group included in the upper group.

According to an embodiment, the electronic device 101 may identify a precise pose mapped to the received image (e.g., a CAD image mapped to the received image) among a plurality of poses (e.g., CAD images) included in the group.

According to an embodiment, the electronic device 101 may identify a plurality of poses of the group including the initial pose corresponding to the received image among a plurality of poses of the object, and identify a pose mapped to the received image among the plurality of poses of the lower group including the initial pose.

According to an embodiment, the electronic device 101 may identify the pose mapped to the received image based on similarities with the received image among the plurality of poses included in the identified group.

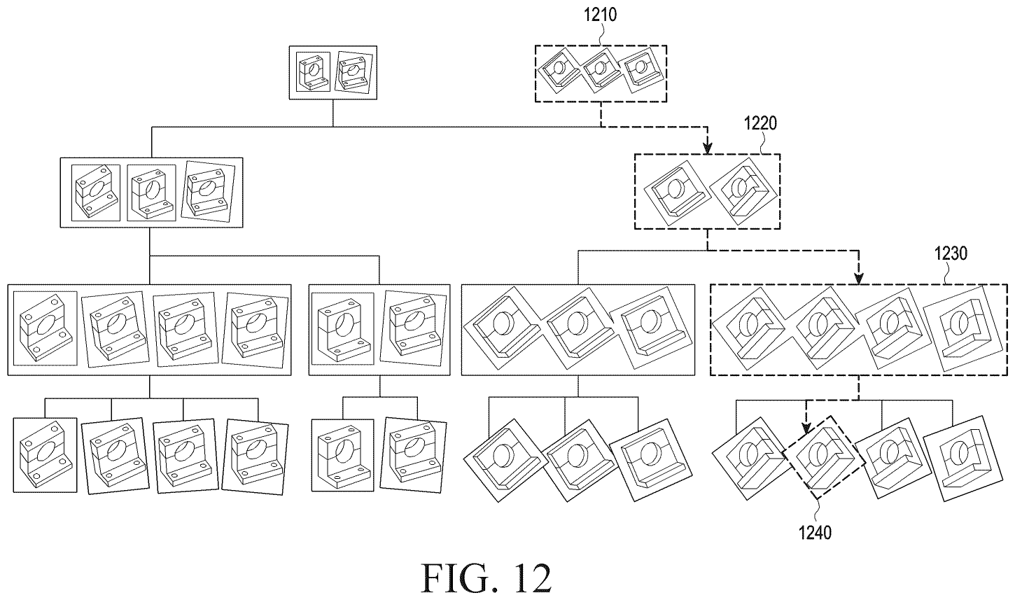

According to an embodiment, the operation of obtaining the pose (e.g., CAD image) mapped to the image received from the external electronic device 104 will be described in more detail with reference to FIG. 12 below.

According to an embodiment, in operation 1160, the electronic device 101 may obtain a precise pose result.

According to an embodiment, in operation 1170, the electronic device 101 may modify the CAD image based on the pose result.

According to an embodiment, the electronic device 101 may compare the mapped CAD image with the received image, and when at least one feature value included in the received image is different from at least one feature value included in the mapped CAD image by a set range or more, the electronic device may identify the at least one feature vale as a defective portion of the object included in the received image.

According to an embodiment, the electronic device 101 may modify the CAD image to display the included defective portion in the mapped CAD image.

According to an embodiment, the electronic device 101 may modify the CAD image to include an assembly guide for assembling the object included in the received image as a part of an assembly based on information related to the mapped CAD image.

According to an embodiment, the electronic device 101 may transmit the modified CAD image to the external electronic device 104.

According to an embodiment, in operation 1180, the external electronic device 104 may display modified CAD data.

According to an embodiment, the external electronic device 104 may provide a guide for identifying the defective portion of the objector the assembly guide through the display.

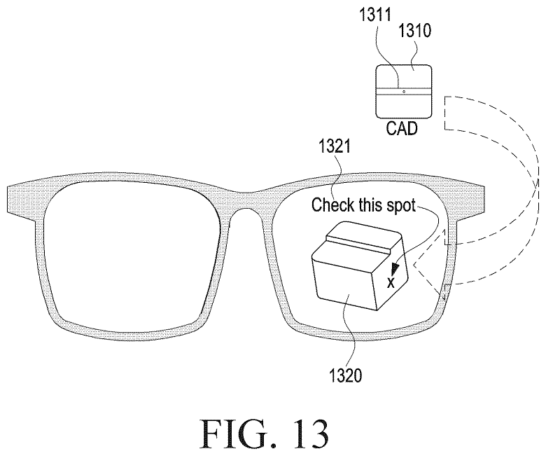

According to an embodiment, the operation of displaying the modified CAD data in the external electronic device 104 will be described below with reference to FIG. 13.

Since the defective portion or assembly guide is displayed by reflecting the pose of the object in this manner, a more intuitive guide may be provided to the user.

FIG. 12 is a diagram illustrating an operation of identifying a mapped CAD image based on a classification structure of object CAD images in an electronic device according to an embodiment of the disclosure.

M Referring to FIG. 12, the electronic device (e.g., the electronic device 101 of FIG. 1, the processor 120 of FIG. 1, the electronic device 200 of FIG. 2, the electronic device 300 of FIG. 3A or 3B, or the electronic device 400 of FIG. 4) may identify a representative CAD image 1210 corresponding to an image of an object.

According to an embodiment, the electronic device may obtain the representative CAD image 1210 corresponding to the image of the object as output data through a trained deep learning model, or may obtain the representative CAD image 1210 corresponding to the image of the object among a plurality of representative CAD images based on similarities.

According to an embodiment, the electronic device may identify images of an upper group 1220 including the representative CAD image 1210, and identify a lower group 1230 corresponding to the image of the object among a plurality of lower groups included in the upper group 1220 based on similarities.

According to an embodiment, the electronic device may identify a CAD image 1240 mapped to the image of the object among a plurality of CAD images included in the lower group 1230 based on similarities.

As a representative CAD image (or an initial pose) is identified and then a mapped CAD image is identified only in a plurality of CAD images related to the representative CAD image in this manner, search resources and a search time may be reduced, compared to searching all pixel areas.

FIG. 13 is a diagram illustrating an operation of using an identified CAD image in an electronic device according to an embodiment of the disclosure.

Referring to FIG. 13, the electronic device (e.g., the electronic device 101 of FIG. 1, the electronic device 200 of FIG. 2, the electronic device 300 of FIG. 3A or 3B, or the electronic device 400 of FIG. 4) may modify a CAD image 1310 of an object by displaying a portion 1311 that needs to be checked in the CAD image 1310 of the object mapped to a captured image of the object.

According to an embodiment, the electronic device may display a modified CAD image 1320. According to an embodiment, the electronic device may further display a guide phrase 1321 for checking, along with the modified CAD image 1320.

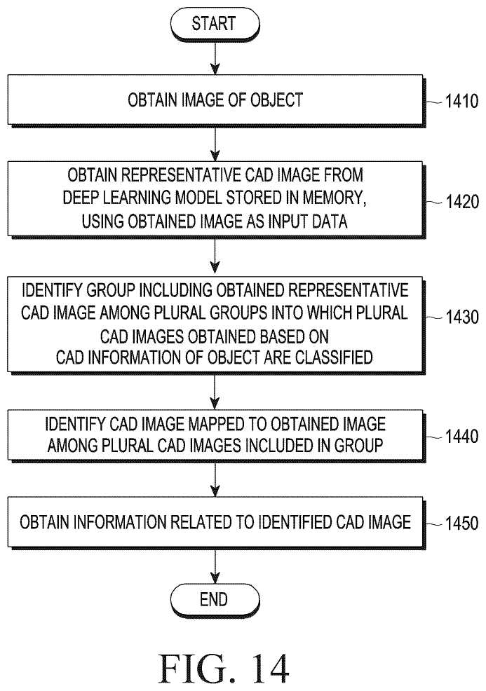

FIG. 14 is a flowchart illustrating an object identification operation using a deep learning model in a wearable electronic device according to an embodiment of the disclosure.

According to an embodiment, FIG. 14 is a diagram illustrating an operation of training a deep learning model, when an electronic device is a wearable electronic device (e.g., AR glasses and/or an HMD device).

Referring to FIG. 14, in operation 1410, the electronic device (e.g., the electronic device 104 of FIG. 1, the electronic device 200 of FIG. 2, the electronic device 300 of FIG. 3A or 3B, or the electronic device 400 of FIG. 4) may obtain an image of an object.

According to an embodiment, the electronic device may obtain the image of the object through a camera (e.g., the camera module 180 of FIG. 1, the second camera module 253 of FIG. 2, the third camera module 255 of FIG. 2, or the camera modules 311, 312, 313, 314, 315, and 316 of FIG. 3A).

According to an embodiment, the image may be an image received from an external electronic device by the electronic device or an image captured after a guide image generated by the electronic device is displayed on the electronic device.

According to an embodiment, in operation 1420, the electronic device may obtain a representative CAD image from a deep learning model stored in memory (e.g., the memory 130 of FIG. 1) using the obtained image as input data.

According to an embodiment, the electronic device may obtain the representative CAD image corresponding to the obtained image based on a similarity between the obtained image and each of a plurality of representative CAD images.

According to an embodiment, in operation 1430, the electronic device may identify a group including the obtained representative CAD image among a plurality of groups into which a plurality of CAD images obtained based on CAD information of the object have been classified.

According to an embodiment, the electronic device may identify an upper group including the representative CAD image and each lower group included in the upper group.

According to an embodiment, in operation 1440, the electronic device may identify a CAD image mapped to the obtained image among a plurality of CAD images included in the group.

According to an embodiment, the electronic device may identify a plurality of CAD images of the group including the representative CAD image corresponding to the obtained image among the plurality of CAD images of the object, and identify a CAD image mapped to the obtained image among the plurality of CAD images of the lower group including the representative CAD image.

According to an embodiment, the electronic device may identify the CAD image mapped to the obtained image among the plurality of CAD images included in the identified group based on similarities.

According to an embodiment, in operation 1450, the electronic device may obtain information related to the identified CAD image.

According to an embodiment, the electronic device may identify a defective portion of the object included in the obtained image based on the information related to the mapped CAD image, and display an image including a guide for guiding the defective portion to be identified.

According to an embodiment, the electronic device may identify the defective portion of the object by comparing the mapped CAD image with the obtained image. For example, the electronic device may identify the defective portion of the object included in the obtained image by comparing the mapped CAD image with the obtained image, and when at least one feature value included in the obtained image is different from at least one feature value included in the mapped CAD image by a set range or more, the electronic device may identify the at least one feature value as a defective portion of the object included in the obtained image.

According to an embodiment, the electronic device may display an image including an assembly guide for assembling the object included in the obtained image as a part of an assembly based on the information related to the mapped CAD image.

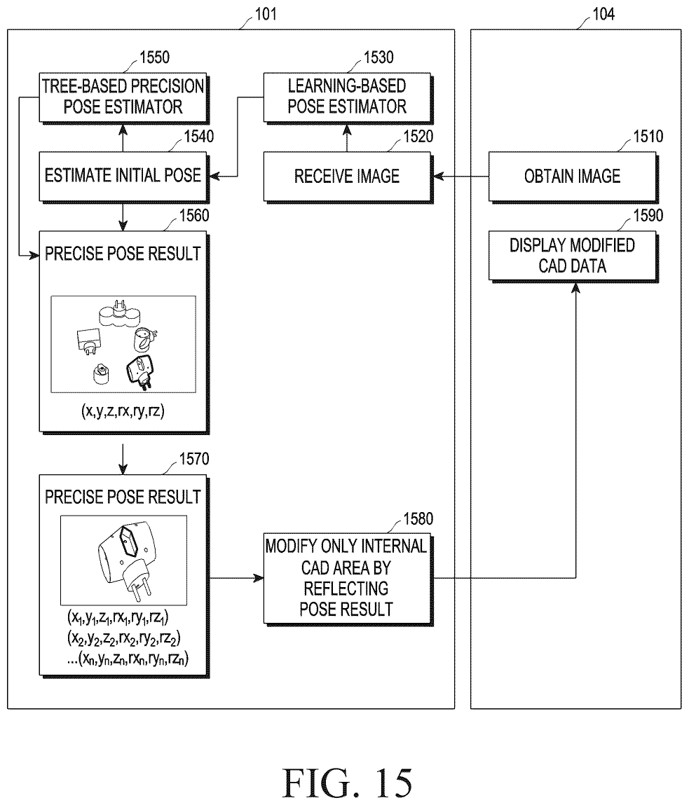

FIG. 15 is a diagram illustrating an operation of precisely identifying an object based on a mapped CAD image in an electronic device according to an embodiment of the disclosure.

Referring to FIG. 15, in operation 1510, the external electronic device 104 (e.g., the electronic device 104 of FIG. 1, the electronic device 200 of FIG. 2, the electronic device 300 of FIG. 3A or 3B, or the electronic device 400 of FIG. 4) may obtain an image.

According to an embodiment, in operation 1520, the electronic device 101 may receive the image from the external electronic device 104.

According to an embodiment, the electronic device 101 may input the received image to a learning-based pose estimator 1530 (e.g., a deep learning model).

According to an embodiment, in operation 1540, the electronic device 101 may estimate an initial pose.

According to an embodiment, in operation 1550, the electronic device 101 may input the initial pose to a tree-based precise pose estimator.

According to an embodiment, in operation 1560, the electronic device 101 may obtain a precise pose result. According to an embodiment, the electronic device 101 may obtain a CAD image mapped to the image of the object among a plurality of CAD images of the object.

According to an embodiment, operations 1510 to 1560 are the same as operations 1110 to 1160 of FIG. 11, and thus, a redundant description is avoided.

According to an embodiment, in operation 1570, individual precise pose values may be obtained. According to an embodiment, the electronic device may obtain the CAD image mapped to the image of the object and individually estimate precise poses of a plurality of areas of the object. For example, when a physical key included in the object includes a printed area, the printed area also moves according to movement of the physical key. Therefore, the electronic device 101 may estimate and correct the movement of the physical key based on the CAD image, and identify whether the printed area is defective.

According to an embodiment, in operation 1580, the electronic device 101 may correct a CAD internal area by reflecting the pose result.

According to an embodiment, upon identifying a defect in a portion of the object, the electronic device 101 may modify the CAD image to include a guide for guiding a defective portion or assembly portion to be identified.

According to an embodiment, the electronic device 101 may transmit the modified CAD image to the external electronic device 104.

According to an embodiment, in operation 1590, the external electronic device 104 may display modified CAD data.

According to an embodiment, the external electronic device 104 may display CAD data including a defective portion identification guide or an assembly guide.

While the electronic device 101 and the external electronic device 104 are shown and described as separate devices in FIG. 15, the operations of the electronic device 101 and the external electronic device 104 may be performed in one device according to an embodiment. For example, when the electronic device 101 is AR glasses, operations 1510 and 1590 may also be performed by the electronic device 101.

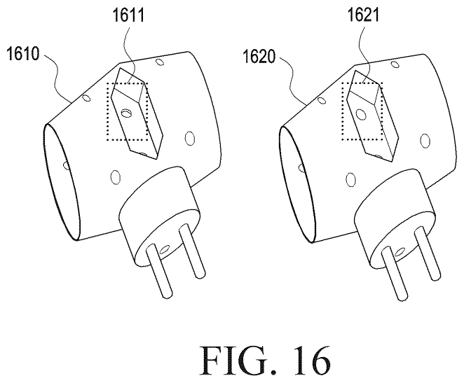

FIG. 16 is a diagram illustrating a precise identification operation of an electronic device according to an embodiment of the disclosure.

Referring to FIG. 16, the electronic device (e.g., the electronic device 104 of FIG. 1, the electronic device 200 of FIG. 2, the electronic device 300 of FIG. 3A or 3B, or the electronic device 400 of FIG. 4) may identify a CAD image 1610 mapped to an image 1620 of an object among a plurality of CAD images of the object.

According to an embodiment, the electronic device may obtain a representative CAD image by inputting the image 1620 of the object into a trained deep learning model, and identify the CAD image 1610 mapped to the image 1620 of the object among a plurality of CAD images of a group including the representative CAD image.

According to an embodiment, the electronic device may identify a difference in a detailed area of the object by comparing the CAD image 1610 with the image 1620 of the object. According to an embodiment, the electronic device may compare at least one feature value included in the CAD image 1610 with at least one feature value included in the image 1620 of the object, and identify areas 1611 and 1621 between which feature values differ by a set range or more, as defective areas.

According to an embodiment, the electronic device may modify the CAD image 1610 to display a guide for guiding the defective area 1611 of the CAD image 1610 to be identified, and transmit the modified CAD image to the external electronic device (e.g., AR glasses) or display it on a display of the electronic device which is AR glasses.

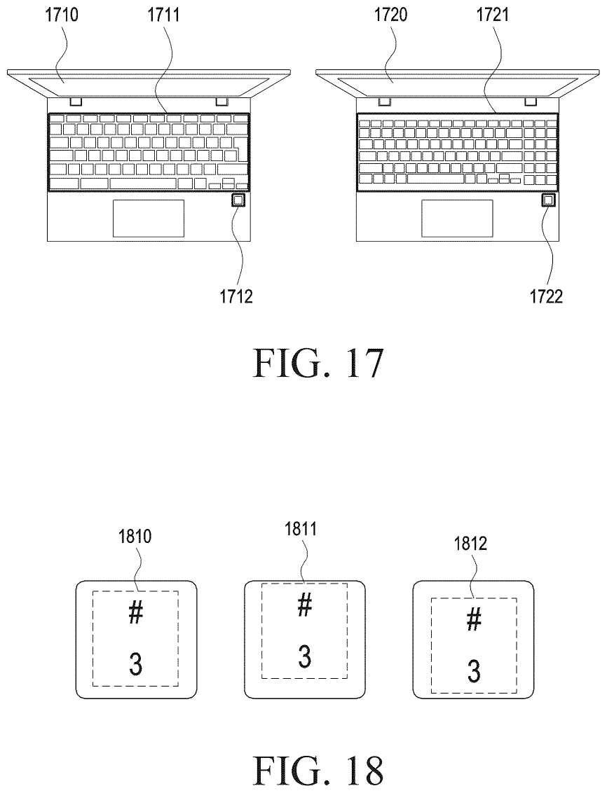

FIG. 17 is a diagram illustrating a precise identification operation of an electronic device according to an embodiment of the disclosure.

Referring to FIG. 17, the electronic device (e.g., the electronic device 104 of FIG. 1, the electronic device 200 of FIG. 2, the electronic device 300 of FIG. 3A or 3B, or the electronic device 400 of FIG. 4) may obtain a representative CAD image by inputting an image of a first object 1710 into a trained deep learning model, and identify a CAD image mapped to the image of the first object 1710 among CAD images of a group including the representative CAD image.

According to an embodiment, the electronic device may identify a pose of the first object 1710 based on the mapped CAD image. According to an embodiment, the electronic device may identify poses of a first area 1711 and a second area 1712 of the first object 1710 based on the mapped CAD image.

According to an embodiment, even if the object being captured changes to a second object 1720, the electronic device may obtain a representative CAD image by inputting an image of the second object 1720 into the trained deep learning model, and identify a CAD image mapped to the image of the second object 1720 among CAD images of a group including the representative CAD image.

According to an embodiment, the electronic device may identify a pose of the second object 1720 based on the mapped CAD image. According to an embodiment, the electronic device may identify poses of a first area 1721 and a second area 1722 of the second object 1720 based on the mapped CAD image.

As such, even if an object in a CAD image changes, the pose of the object may be estimated using the trained deep learning model.

FIG. 18 is a diagram illustrating a precise identification operation of an electronic device according to an embodiment of the disclosure.

Referring to FIG. 18, the electronic device (e.g., the electronic device 104 of FIG. 1, the electronic device 200 of FIG. 2, the electronic device 300 of FIG. 3A or 3B, or the electronic device 400 of FIG. 4) may identify a detailed area of an object after estimating the pose of the object as illustrated in FIG. 17.

According to an embodiment, the electronic device may identify whether there is a difference in a detailed area based on a feature value of the object by comparing an image of the object with a mapped CAD image. For example, when the object is a laptop, the electronic device may compare a printed area 1810 of a key included in the CAD image of the object with a printed area 1811 or 1812 of the key in the object to determine whether there is a defect based on whether the difference in the position and/or spacing of the printed area is equal to or greater than a set range.

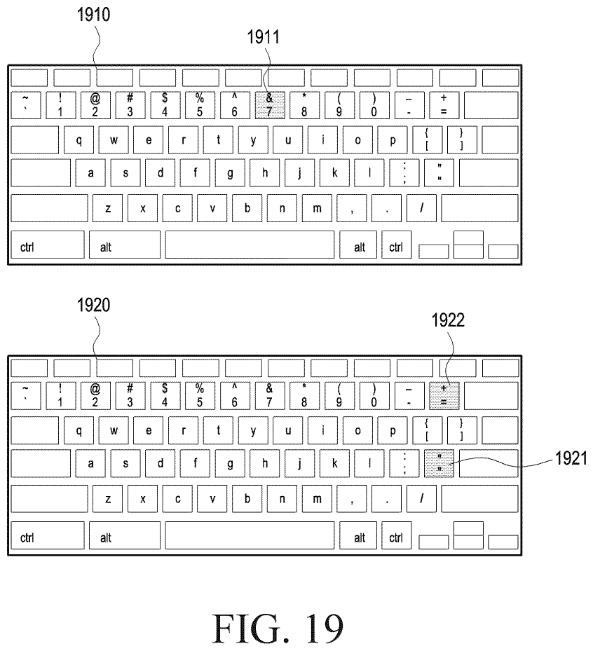

FIG. 19 is a diagram illustrating a precise identification operation of an electronic device according to an embodiment of the disclosure.

Referring to FIG. 19, the electronic device (e.g., the electronic device 104 of FIG. 1, the electronic device 200 of FIG. 2, the electronic device 300 of FIG. 3A or 3B, or the electronic device 400 of FIG. 4) may identify a defective portion 1911 of a first object 1910 by comparing an image of the first object 1910 with a CAD image mapped to it, and identify defective portions 1921 and 1922 of a second object 1920 by comparing an image of the second object 1920 with a CAD image mapped to it.

According to an embodiment, the electronic device may display a guide for guiding identification of an area corresponding to the defective portion 1911 of the first object 1910 on the CAD image mapped to the image of the first object 1910, and transmit the CAD image with the guide displayed thereon, which is mapped to the image of the first object 1910 to an external electronic device (e.g., AR glasses) or display the CAD image on a display of the electronic device which is AR glasses.

According to an embodiment, the electronic device may display a guide for guiding identification of an area corresponding to the defective portion 1921 of the second object 1920 on the CAD image mapped to the image of the second object 1920, and transmit the mapped CAD image with the guide displayed thereon to the external electronic device (e.g., AR glasses) or display the CAD image on the display of the electronic device which is AR glasses.

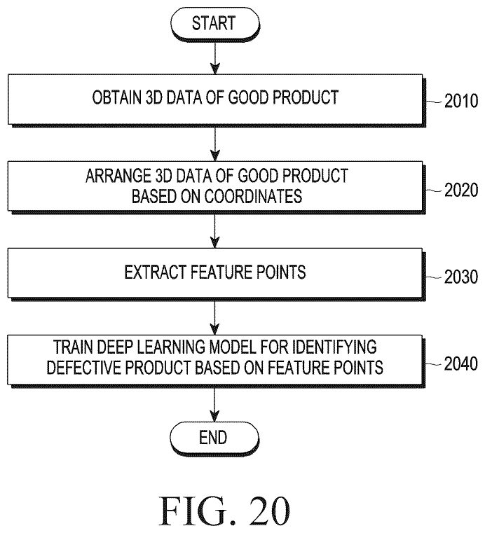

FIG. 20 is a flowchart illustrating an operation of training a deep learning model for identifying whether an object is defective based on 3D data in an electronic device according to an embodiment of the disclosure.

Referring to FIG. 20, in operation 2010, the electronic device (e.g., the electronic device 101 of FIG. 1, the processor 120 of FIG. 1, the electronic device 200 of FIG. 2, the electronic device 300 of FIG. 3A or 3B, or the electronic device 400 of FIG. 4) may obtain 3D data of a good product.

According to an embodiment, the electronic device may obtain the 3D data of the good product based on an image obtained through a camera (e.g., the camera module 180 of FIG. 1, the second camera module 253 of FIG. 2, the third camera module 255 of FIG. 2, or the camera modules 311, 312, 313, 314, 315, and 316 of FIG. 3A), or may obtain the 3D data of the good product based on an image obtained through a camera of an external electronic device. According to an embodiment, the 3D data may be point cloud data.

According to an embodiment, in operation 2020, the electronic device may arrange the 3D data of the good product based on coordinates.

According to an embodiment, the electronic device may arrange the 3D data to have the same coordinate axis, or may reflect a coordinate axis in each of the 3D data. In this way, even if the pose of an object changes, a defective portion may be identified by arranging 3D data based on coordinates.

According to an embodiment, the electronic device may augment the arranged data to increase the transformation invariance of the deep learning model.

According to an embodiment, in operation 2030, the electronic device may extract feature points.

According to an embodiment, the electronic device may extract feature points from the 3D data arranged based on coordinates. For example, the electronic device may extract the feature points from the point cloud data. For example, feature points that are independent of the pose (or rotation) of the object may be a fast point feature histogram (FPFH).

According to an embodiment, in operation 2040, the electronic device may train the deep learning model for identifying a defective product based on the feature points.

According to an embodiment, the electronic device may use a small amount of the 3D data of the good product as training data to cause the deep learning model to learn the characteristics of the good product, such that when an image of the defective product is input, a defective portion is output.

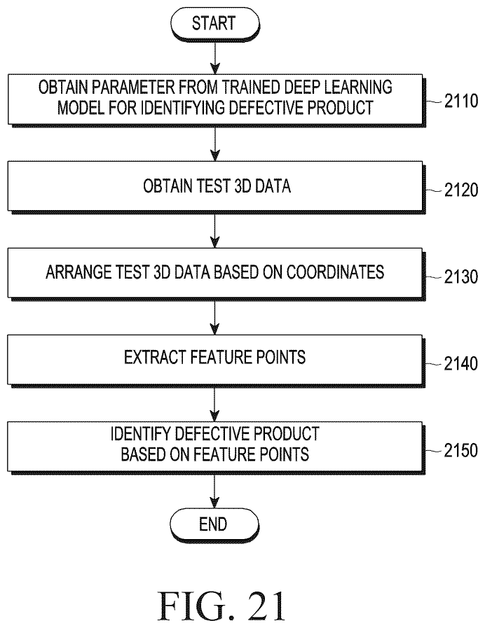

FIG. 21 is a flowchart illustrating an operation of identifying whether an object is defective using a deep learning model trained based on 3D data in an electronic device according to an embodiment of the disclosure.

Referring to FIG. 21, in operation 2110, the electronic device (e.g., the electronic device 101 of FIG. 1, the processor 120 of FIG. 1, the electronic device 200 of FIG. 2, the electronic device 300 of FIG. 3A or 3B, or the electronic device 400 of FIG. 4) may obtain parameters from a trained deep learning model for identifying a defective product.

According to an embodiment, the parameters obtained from the deep learning model may be feature values of a good product.

According to an embodiment, in operation 2120, the electronic device may obtain test 3D data. According to an embodiment, the electronic device may obtain 3D data of a product requiring testing through a camera (e.g., the camera module 180 of FIG. 1, the second camera module 253 of FIG. 2, the third camera module 255 of FIG. 2, or the camera modules 311, 312, 313, 314, 315, and 316 of FIG. 3A), or may obtain the test 3D data based on an image of the product requiring testing obtained through a camera of an external electronic device. According to an embodiment, the 3D data may be point cloud data.

According to an embodiment, in operation 2130, the electronic device may arrange the test 3D data based on coordinates.

According to an embodiment, in operation 2140, the electronic device may obtain feature points.

According to an embodiment, in operation 2150, the electronic device may identify the defective product based on the feature points.

According to an embodiment, the electronic device may arrange the test 3D data based on the coordinates, and identify a defective portion by inputting the arranged test 3D data into the deep learning model to which learned parameters are applied.

According to an embodiment, the electronic device may identify a defective portion by comparing the feature points of the 3D data of the good product with the feature points of the test 3D data based on the deep learning model.

In this way, even if training is performed only on data of a good product without performing training on each defective portion, the defective portion may be identified.

According to an embodiment, an electronic device includes a communication module, and at least one processor operatively connected to the communication module.

According to an embodiment, the at least one processor may obtain a plurality of CAD images based on CAD information of an object.

According to an embodiment, the at least one processor may classify the plurality of CAD images into a plurality of groups based on similarities between the plurality of CAD images.

According to an embodiment, the at least one processor may transmit a representative CAD image of each of the plurality of groups to an external electronic device.

According to an embodiment, the at least one processor may receive an image of the object captured by the external electronic device, corresponding to the representative CAD image, from the external electronic device.

According to an embodiment, the at least one processor may train a learning model to output the representative CAD image, using the received image of the object as training data.

According to an embodiment, the at least one processor may sequentially transmit, to the external electronic device, a first guide image including a first CAD image related to a first pose of the object and a second guide image including a second CAD image related to a second pose of the object among the plurality of representative CAD images.

According to an embodiment, at least one of the first guide image or the second guide image may include a guide for guiding a pose of the object to be changed.

According to an embodiment, the at least one processor may classify the plurality of CAD images into a plurality of first groups based on similarities.

According to an embodiment, the at least one processor may identify a plurality of first representative CAD images corresponding to the plurality of first groups, respectively.

According to an embodiment, the at least one processor may classify the plurality of first representative CAD images into a plurality of second groups based on similarities.

According to an embodiment, the at least one processor may identify a plurality of second representative CAD images corresponding to the plurality of second groups, respectively.

According to an embodiment, the at least one processor may transmit the plurality of second representative CAD images as the representative CAD images to the external electronic device.

According to an embodiment, the external electronic device may be AR glasses.

According to an embodiment, an electronic device includes a communication module and at least one processor operatively connected to the memory and the communication module.

According to an embodiment, the at least one processor may receive an image of an object captured by an external electronic device from the external electronic device.

According to an embodiment, the at least one processor may obtain a representative CAD image from a learning model stored in the memory, using the received image as input data.

According to an embodiment, the at least one processor may identify a group including the obtained representative CAD image among a plurality of groups into which a plurality of CAD images obtained based on CAD information of the object are classified.

According to an embodiment, the at least one processor may identify a CAD image mapped to the received image among a plurality of CAD images included in the group.

According to an embodiment, the at least one processor may transmit information related to the mapped CAD image to the external electronic device.

According to an embodiment, the learning model may be trained to output a representative CAD image, using the plurality of CAD images obtained based on the CAD information of the object as training data.

According to an embodiment, the at least one processor may identify the mapped CAD image among the plurality of CAD images included in the group based on similarities with the received image.

According to an embodiment, the at least one processor may identify a defective portion of the object included in the received image based on the information related to the mapped CAD image.

According to an embodiment, the at least one processor may transmit an image including a guide for guiding the defective portion to be identified to the external electronic device.

According to an embodiment, the at least one processor may compare the mapped CAD image with the received image, and when at least one feature value included in the received image is different from at least one feature value included in the mapped CAD image by a set range or more, identify the at least one feature value as the defective portion of the object.

According to an embodiment, the at least one processor may transmit, to the external electronic device, an image including an assembly guide for assembling the object included in the received image as a part of an assembly based on the information related to the mapped CAD image.

According to an embodiment, a method of controlling an electronic device may include obtaining a plurality of CAD images based on CAD information of an object.

According to an embodiment, the method of controlling the electronic device may include classifying the plurality of CAD images into a plurality of groups based on similarities between the plurality of CAD images.

According to an embodiment, the method of controlling the electronic device may include transmitting a representative CAD image of each of the plurality of groups to an external electronic device.

According to an embodiment, the method of controlling the electronic device may include receiving an image of the object captured by the external electronic device, corresponding to the representative CAD image, from the external electronic device.

According to an embodiment, the method of controlling the electronic device may include training a learning model to output the representative CAD image, using the received image of the object as training data.

According to an embodiment, transmitting the representative CAD image of each of the plurality of groups to the external electronic device may include sequentially transmitting, to the external electronic device, a first guide image including a first CAD image related to a first pose of the object and a second guide image including a second CAD image related to a second pose of the object among the plurality of representative CAD images.

According to an embodiment, at least one of the first guide image or the second guide image may include a guide for guiding a pose of the object to be changed.

According to an embodiment, classifying the plurality of CAD images into the plurality of groups based on the similarities between the plurality of CAD images may include classifying the plurality of CAD images into a plurality of first groups based on similarities.

According to an embodiment, classifying the plurality of CAD images into the plurality of groups based on the similarities between the plurality of CAD images may include identifying a plurality of first representative CAD images corresponding to the plurality of first groups, respectively.

According to an embodiment, classifying the plurality of CAD images into the plurality of groups based on the similarities between the plurality of CAD images may include classifying the plurality of first representative CAD images into a plurality of second groups based on similarities.

According to an embodiment, transmitting the representative CAD image of each of the plurality of groups to the external electronic device may include identifying a plurality of second representative CAD images corresponding to the plurality of second groups, respectively.

According to an embodiment, transmitting the representative CAD image of each of the plurality of groups to the external electronic device may include transmitting the plurality of second representative CAD images as the representative CAD images to the external electronic device.

According to an embodiment, the external electronic device may be AR glasses.

According to an embodiment, a method of controlling an electronic device may include receiving an image of an object captured by an external electronic device from the external electronic device.

According to an embodiment, the method of controlling the electronic device may include obtaining a representative CAD image from a learning model stored in the memory, using the received image as input data.

According to an embodiment, the method of controlling the electronic device may include identifying a group including the obtained representative CAD image among a plurality of groups into which a plurality of CAD images obtained based on CAD information of the object are classified.

According to an embodiment, the method of controlling the electronic device may include identifying a CAD image mapped to the received image among a plurality of CAD images included in the group.

According to an embodiment, the method of controlling the electronic device may include transmitting information related to the mapped CAD image to the external electronic device.

According to an embodiment, the learning model may be trained to output a representative CAD image, using the plurality of CAD images obtained based on the CAD information of the object as training data.

According to an embodiment, identifying the CAD image mapped to the received image among the plurality of CAD images included in the group may include identifying the mapped CAD image among the plurality of CAD images included in the group based on similarities with the received image.

According to an embodiment, the method of controlling the electronic device may further include identifying a defective portion of the object included in the received image based on the information related to the mapped CAD image.

According to an embodiment, transmitting the information related to the mapped CAD image may include transmitting an image including a guide for guiding the defective portion to be identified to the external electronic device.

According to an embodiment, identifying the defective portion of the object may include comparing the mapped CAD image with the received image, and when at least one feature value included in the received image is different from at least one feature value included in the mapped CAD image by a set range or more, identifying the at least one feature value as the defective portion of the object.

According to an embodiment, transmitting the information related to the mapped CAD image to the external electronic device may include transmitting, to the external electronic device, an image including an assembly guide for assembling the object included in the received image as a part of an assembly based on the information related to the mapped CAD image.

According to an embodiment, in a non-transitory computer-readable storage medium storing at least one program, the at least one program may include instructions that enable an electronic device to obtain a plurality of CAD images based on CAD information of an object.

According to an embodiment, the at least one program may include instructions that enable the electronic device to classify the plurality of CAD images into a plurality of groups based on similarities between the plurality of CAD images.

According to an embodiment, the at least one program may include instructions that enable the electronic device to transmit a representative CAD image of each of the plurality of groups to an external electronic device.

According to an embodiment, the at least one program may include instructions that enable the electronic device to receive an image of the object captured by the external electronic device, corresponding to the representative CAD image, from the external electronic device.

According to an embodiment, the at least one program may include instructions that enable the electronic device to train a learning model to output the representative CAD image, using the received image of the object as training data.

According to an embodiment, the at least one program may include instructions that enable the electronic device to sequentially transmit, to the external electronic device, a first guide image including a first CAD image related to a first pose of the object and a second guide image including a second CAD image related to a second pose of the object among the plurality of representative CAD images.

According to an embodiment, at least one of the first guide image or the second guide image may include a guide for guiding a pose of the object to be changed.

According to an embodiment, the at least one program may include instructions that enable the electronic device to classify the plurality of CAD images into a plurality of first groups based on similarities.

According to an embodiment, the at least one program may include instructions that enable the electronic device to identify a plurality of first representative CAD images corresponding to the plurality of first groups, respectively.

According to an embodiment, the at least one program may include instructions that enable the electronic device to classify the plurality of first representative CAD images into a plurality of second groups based on similarities.

According to an embodiment, the at least one program may include instructions that enable the electronic device to identify a plurality of second representative CAD images corresponding to the plurality of second groups, respectively.

According to an embodiment, the at least one program may include instructions that enable the electronic device to transmit the plurality of second representative CAD images as the representative CAD images to the external electronic device.

According to an embodiment, the external electronic device may be AR glasses.

According to an embodiment, in a non-transitory computer-readable storage medium storing at least one program, the at least one program may include instructions that enable an electronic device to receive an image of an object captured by an external electronic device from the external electronic device.

According to an embodiment, the at least one program may include instructions that enable the electronic device to obtain a representative CAD image from a learning model stored in the memory, using the received image as input data.

According to an embodiment, the at least one program may include instructions that enable the electronic device to identify a group including the obtained representative CAD image among a plurality of groups into which a plurality of CAD images obtained based on CAD information of the object are classified.

According to an embodiment, the at least one program may include instructions that enable the electronic device to identify a CAD image mapped to the received image among a plurality of CAD images included in the group.

According to an embodiment, the at least one program may include instructions that enable the electronic device to transmit information related to the mapped CAD image to the external electronic device.

According to an embodiment, the learning model may be trained to output a representative CAD image, using the plurality of CAD images obtained based on the CAD information of the object as training data.

According to an embodiment, the at least one program may include instructions that enable the electronic device to identify the mapped CAD image among the plurality of CAD images included in the group based on similarities with the received image.

According to an embodiment, the at least one program may include instructions that enable the electronic device to identify a defective portion of the object included in the received image based on the information related to the mapped CAD image.

According to an embodiment, the at least one program may include instructions that enable the electronic device to transmit an image including a guide for guiding the defective portion to be identified to the external electronic device.

According to an embodiment, the at least one program may include instructions that enable the electronic device to compare the mapped CAD image with the received image, and when at least one feature value included in the received image is different from at least one feature value included in the mapped CAD image by a set range or more, identify the at least one feature value as the defective portion of the object.

According to an embodiment, the at least one program may include instructions that enable the electronic device to transmit, to the external electronic device, an image including an assembly guide for assembling the object included in the received image as a part of an assembly based on the information related to the mapped CAD image.

The electronic device according to embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or a plurality of entities, and some of the plurality of entities may be separately disposed in different components. According to embodiments, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A n electronic device comprising:
communication circuitry;
memory storing one or more computer programs; and
one or more processors communicatively coupled to the communication circuitry and the memory,
wherein the one or more computer programs include computer-executable instructions that, when executed by the one or more processors individually or collectively, cause the electronic device to:
obtain a plurality of computer-aided design (CAD) images based on CAD information of an object,
classify the plurality of CAD images into a plurality of groups based on similarities between the plurality of CAD images,
transmit a representative CAD image of each of the plurality of groups to an external electronic device,
receive an image of the object captured by the external electronic device, corresponding to the representative CAD image, from the external electronic device, and
generate a learning model to output the representative CAD image, using the received image of the object as training data.

2. The electronic device of claim 1, wherein the one or more computer programs further include computer-executable instructions that, when executed by the one or more processors individually or collectively, cause the electronic device to sequentially transmit, to the external electronic device, a first guide image including a first CAD image related to a first pose of the object and a second guide image including a second CAD image related to a second pose of the object among a plurality of representative CAD images.

3. The electronic device of claim 2, wherein at least one of the first guide image or the second guide image includes a guide for guiding a pose of the object to be changed.

4. The electronic device of claim 1, wherein the one or more computer programs further include computer-executable instructions that, when executed by the one or more processors individually or collectively, cause the electronic device to:
classify the plurality of CAD images into a plurality of first groups based on similarities,
identify a plurality of first representative CAD images corresponding to the plurality of first groups, respectively,
classify the plurality of first representative CAD images into a plurality of second groups based on similarities,
identify a plurality of second representative CAD images corresponding to the plurality of second groups, respectively, and
transmit the plurality of second representative CAD images as the representative CAD images to the external electronic device.

5. The electronic device of claim 1, wherein the external electronic device is augmented reality (AR) glasses.

6. A n electronic device comprising:
communication circuitry;
memory storing one or more computer programs; and
one or more processors communicatively coupled to the communication circuitry and the memory,
wherein the one or more computer programs include computer-executable instructions that, when executed by the one or more processors individually or collectively, cause the electronic device to:
receive an image of an object captured by an external electronic device from the external electronic device,
obtain a representative computer-aided design (CAD) image from a learning model stored in the memory, using the received image as input data,
identify a group including the obtained representative CAD image among a plurality of groups into which a plurality of CAD images obtained based on CAD information of the object are classified,
identify a CAD image mapped to the received image among a plurality of CAD images included in the group, and
transmit information related to the mapped CAD image to the external electronic device, and
wherein the learning model is trained to output a representative CAD image, using the plurality of CAD images obtained based on the CAD information of the object as training data.

7. The electronic device of claim 6, wherein the one or more computer programs further include computer-executable instructions that, when executed by the one or more processors individually or collectively, cause the electronic device to identify the mapped CAD image among the plurality of CAD images included in the group based on similarities with the received image.

8. The electronic device of claim 6, wherein the one or more computer programs further include computer-executable instructions that, when executed by the one or more processors individually or collectively, cause the electronic device to:
identify a defective portion of the object included in the received image based on the information related to the mapped CAD image, and
transmit an image including a guide for guiding the defective portion to be identified to the external electronic device.

9. The electronic device of claim 8, wherein the one or more computer programs further include computer-executable instructions that, when executed by the one or more processors individually or collectively, cause the electronic device to compare the mapped CAD image with the received image, and when at least one feature value included in the received image is different from at least one feature value included in the mapped CAD image by a set range or more, identify the at least one feature value as the defective portion of the object.

10. The electronic device of claim 9, wherein the one or more computer programs further include computer-executable instructions that, when executed by the one or more processors individually or collectively, cause the electronic device to transmit, to the external electronic device, an image including an assembly guide for assembling the object included in the received image as a part of an assembly based on the information related to the mapped CAD image.

11. A method performed by an electronic device, the method comprising:
obtaining, by the electronic device, a plurality of computer-aided design (CAD) images based on CAD information of an object;
classifying, by the electronic device, the plurality of CAD images into a plurality of groups based on similarities between the plurality of CAD images;
transmitting, by the electronic device, a representative CAD image of each of the plurality of groups to an external electronic device;
receiving, by the electronic device, an image of the object captured by the external electronic device, corresponding to the representative CAD image, from the external electronic device; and
generating, by the electronic device, a learning model to output the representative CAD image, using the received image of the object as training data.

12. The method of claim 11, wherein transmitting of the representative CAD image of each of the plurality of groups to the external electronic device includes sequentially transmitting, to the external electronic device, a first guide image including a first CAD image related to a first pose of the object and a second guide image including a second CAD image related to a second pose of the object among a plurality of representative CAD images.

13. The method of claim 12, wherein at least one of the first guide image or the second guide image includes a guide for guiding a pose of the object to be changed.

14. The method of claim 11,
wherein classifying the plurality of CAD images into the plurality of groups based on the similarities between the plurality of CAD images includes:
classifying the plurality of CAD images into a plurality of first groups based on similarities,
identifying a plurality of first representative CAD images corresponding to the plurality of first groups, respectively, and
classifying the plurality of first representative CAD images into a plurality of second groups based on similarities, and
wherein transmitting the representative CAD image of each of the plurality of groups to the external electronic device includes:
identifying a plurality of second representative CAD images corresponding to the plurality of second groups, respectively, and
transmitting the plurality of second representative CAD images as the representative CAD images to the external electronic device.

15. The method of claim 11, wherein the external electronic device is augmented reality (AR) glasses.

16. One or more non-transitory computer-readable storage media storing one or more computer programs including computer-executable instructions that, when executed by one or more processors of an electronic device individually or collectively, cause the electronic device to perform operations, the operations comprising:
obtaining, by the electronic device, a plurality of computer-aided design (CAD) images based on CAD information of an object;
classifying, by the electronic device, the plurality of CAD images into a plurality of groups based on similarities between the plurality of CAD images;
transmitting, by the electronic device, a representative CAD image of each of the plurality of groups to an external electronic device;
receiving, by the electronic device, an image of the object captured by the external electronic device, corresponding to the representative CAD image, from the external electronic device; and
generating, by the electronic device, a learning model to output the representative CAD image, using the received image of the object as training data.

17. The one or more non-transitory computer-readable storage media of claim 16, wherein transmitting of the representative CAD image of each of the plurality of groups to the external electronic device includes sequentially transmitting, to the external electronic device, a first guide image including a first CAD image related to a first pose of the object and a second guide image including a second CAD image related to a second pose of the object among a plurality of representative CAD images.

18. The one or more non-transitory computer-readable storage media of claim 17, wherein at least one of the first guide image or the second guide image includes a guide for guiding a pose of the object to be changed.

19. The one or more non-transitory computer-readable storage media of claim 16,
wherein classifying the plurality of CAD images into the plurality of groups based on the similarities between the plurality of CAD images includes:
classifying the plurality of CAD images into a plurality of first groups based on similarities,
identifying a plurality of first representative CAD images corresponding to the plurality of first groups, respectively, and
classifying the plurality of first representative CAD images into a plurality of second groups based on similarities, and
wherein transmitting the representative CAD image of each of the plurality of groups to the external electronic device includes:
identifying a plurality of second representative CAD images corresponding to the plurality of second groups, respectively, and
transmitting the plurality of second representative CAD images as the representative CAD images to the external electronic device.

20. The one or more non-transitory computer-readable storage media of claim 16, wherein the external electronic device is augmented reality (AR) glasses.
